(19) United States
(12) Patent Application Publication
(10) Pub. No.: US 2026/0218670 A1
(43) Pub. Date: Jul. 30, 2026

(54) AIR TURBOROCKET APPARATUS WITH PRECOOLER HEAT EXCHANGER AT THE AIR INTAKE

(71) Applicant: DESTINUS SA, Payerne (CH)

(72) Inventors: Ferran ROIG TIÓ, Payerne (CH); Mikhail KOKORICH, Payerne (CH)

(21) Appl. No.: 19/142,114

(22) PCT Filed: Dec. 22, 2022
(86) PCT No.: PCT/EP2022/087560

§ 371 Date: Jun. 20, 2025

(51) Int. Cl. F02K 9/78; B64D 27/02; B64D 33/02; B64D 37/02; F02K 9/46

(52) U.S. Cl. CPC F02K 9/78; B64D 27/023; B64D 33/02; B64D 37/02; F02K 9/46; B64D 2033/024

(57) ABSTRACT

The invention relates to an air turborocket apparatus (10) comprising an air intake (11), a compressor (12), a turbine (13), a combustion chamber (14), a gas generator system including a preburner (18) and a driving system (17), and a coupling system (19). The coupling system is configured to couple the turbine with the compressor and/or the driving system. The driving system is configured to drive fuel along two flow paths (P1, P2), i.e., a first flow path (P1) and a second flow path (P2). The first flow path (P1) extends to the combustion chamber via the preburner and the turbine. The second flow path (P2) extends to the preburner and/or the combustion chamber via a heat exchanger (21), which is in thermal communication with the air intake and acts as an air precooler. The invention is further directed to related apparatuses, aircrafts, and methods.

### TECHNICAL FIELD

The invention relates in general to the field of air turborocket apparatuses. In particular, it is directed to an air turborocket apparatus including a fuel circuit with two subcircuits, where a first subcircuit extends to the combustion chamber via the preburner and the turbine, while the second subcircuit extends to the preburner or the combustion chamber, via a heat exchanger in thermal communication with the air intake, such that the heat exchanger acts as a precooler.

### BACKGROUND

An air turborocket (also called turboramjet or turboramjet rocket) can be regarded as a combined-cycle jet engine, i.e., an expander cycle engine that uses heat from the combustion to energize the fuel so that it can be expanded in a turbine to drive a fuel pump and/or a compressor.

The speed-induced heating caused by the air flow entering air-breathing engines negatively impacts the performance of supersonic and hypersonic aircrafts, starting with the flight Mach number operational range of the engine(s). Therefore, a new air turborocket design is desired.

### SUMMARY

According to a first aspect, the present invention is embodied as an air turborocket apparatus. The apparatus comprises an air intake, a compressor, a turbine, a combustion chamber, a gas generator system including a preburner and a driving system, and a coupling system. The latter is configured to couple the turbine with one or each of the compressor and the driving system. The driving system is configured to drive fuel along two flow paths, these including a first flow path and a second flow path. The first flow path extends to the combustion chamber via the preburner and the turbine. The second flow path extends to one or each of the preburner and the combustion chamber, via a heat exchanger that is in thermal communication with the air intake.

The proposed solution helps counteract the speed-induced heating of the air flow. This makes it possible to extend the flight Mach number operational range of the engine. Another consequence is that preheating a fraction of the liquid hydrogen saves energy. It may notably reduce the consumption of oxygen injected in the preburner or oxygen present in the compressed air arriving in the combustion chamber.

In embodiments, the air intake has an inner wall that defines a duct forming a passageway for atmospheric air. The heat exchanger includes a conduit forming a portion of the second flow path, whereby the conduit is in thermal contact with atmospheric air drawn through the air intake, in operation. I.e., the conduit serves as a heat exchanger, to improve the efficiency of the heat transfer.

Preferably, the conduit extends along a winding path along at least a portion of the inner wall, whereby successive portions of the conduit are preferably parallel to each other. For example, the conduit is coiled around and/or meandering along the (at least a portion of the) inner wall. This increases the density of fluid in thermal contact with the air flow, in operation. Preferably, the conduit is in direct contact with said inner wall. This ensures a satisfactory thermal contact and, in turn, improves the heat exchange with air breathed by the air intake.

In embodiments, the driving system includes a pump system (e.g., including a centrifugal pump), which is designed to pump fuel. The first flow path and the second flow path form part of a fluid circuit arranged downstream of the pump system. The fluid circuit defines the two flow paths. In operation, the driving system drives the pumped fuel along each of the first flow path and the second flow path.

The second flow path may possibly bifurcate and extend to each of the combustion chamber and the preburner. In preferred embodiments, the second flow path extends to the combustion chamber (but not to the preburner). In variants, the second flow path extends to the preburner (but not to the combustion chamber). In the latter case, the second flow path may for instance branch from the first flow path and branch back into the first flow path or independently lead to the preburner.

Preferably, the coupling system couples the turbine to each of the compressor and the driving system, so as to transfer energy to each of the compressor and the driving system upon rotating the turbine. In variants, the coupling system couples the turbine to the driving system, so as to transfer energy only to the driving system upon rotating the turbine. In other variants, the coupling system couples the turbine to the compressor, so as to transfer energy only to the compressor upon rotating the turbine.

In embodiments, the apparatus includes a casing, which encases the compressor, the turbine, and the combustion chamber, and the preburner is arranged outside of the casing, albeit in fluid communication with the turbine. In variants, the preburner may be fit inside the casing, its dimensions permitting. This, however, may be challenging in terms of design.

According to another aspect, the invention is embodied as an aircraft, which comprises one or more air turborocket apparatuses as described above.

In preferred embodiments, the aircraft further includes one or more fuel tanks, to which the driving system is connected, and each of the one or more fuel tanks preferably contains liquid hydrogen. The aircraft optionally includes a pressurization system designed to pressurize liquid fuel contained in the one or more fuel tanks. The aircraft may further include one or more oxidizer tanks, to which the preburner is connected; each of the one or more oxidizer tanks preferably contains liquid oxygen. The aircraft optionally includes a pressurization system designed to pressurize a liquid oxidizer contained in the one or more oxidizer tanks.

According to a final aspect, the invention is embodied as a method of operating an air turborocket apparatus. The method relies on an air turborocket apparatus as described above. The method revolves around operating the air turborocket apparatus for the air intake to receive atmospheric air, the compressor to compress atmospheric air drawn through the air intake, the driving system to drive fuel along each of the first flow path and the second flow path. I.e., fuel is driven along the first flow path to inject this fuel into the preburner, partly combust the injected fuel, expand a fluid containing the partly combusted fuel through the turbine to rotate the latter (so as to transfer energy to one or each of the compressor and the driving system), and guide the expanded fluid to the combustion chamber, for it to combust a mixture of the compressed atmospheric air and a fluid including the expanded fluid. Fuel is further driven along the second flow path to heat up this fuel via the heat exchanger and inject the heated fuel into the preburner and/or the combustion chamber.

### BRIEF DESCRIPTION OF THE DRAWINGS

These and other objects, features and advantages of the present invention will become apparent from the following detailed description of illustrative embodiments thereof, which is to be read in connection with the accompanying drawings. The illustrations are for clarity in facilitating one skilled in the art in understanding the invention in conjunction with the detailed description. In the drawings:

FIGS. 1 and 2 respectively show a 3D view and a rear view of a high-speed aircraft equipped with an air turborocket, as in embodiments;

FIG. 3 is a 3D view of such an air turborocket, where the preburner is arranged outside of the main engine, according to embodiments;

FIG. 4 is a longitudinal section view that schematically depicts an air intake with a conduit coiled around an inner wall of the air intake, according to embodiments. The conduit forms part of a fuel subcircuit leading to the preburner or the combustion chamber of the air turborocket. The conduits act as a heat exchanger; it is in thermal contact with atmospheric air drawn through the air intake, in operation;

FIG. 5 is a diagram that schematically illustrates the propagation of fuel along a fluid circuit of the air turborocket of FIG. 3, where the circuit includes a first subcircuit leading to the combustion chamber, via the preburner and the turbine subcircuit, as well as a second subcircuit leading to the combustion chamber and/or the preburner, via a circuit portion in thermal contact with the air intake (as in FIG. 4), according to embodiments; and

FIG. 6 is another diagram schematically illustrating selected components of an air turborocket according to embodiments, the function of such components, and how these components interact in operation of the air turborocket, as in embodiments.

The accompanying drawings show simplified representations of devices or parts thereof, as involved in embodiments. Technical features depicted in the drawings are not necessarily to scale. Similar or functionally similar elements in the figures have been allocated the same numeral references, unless otherwise indicated.

Apparatuses, aircrafts, and methods, embodying the present invention will now be described, by way of non-limiting examples.

### DETAILED DESCRIPTION OF EMBODIMENTS OF THE INVENTION

In supersonic or hypersonic flight, the temperature reached by the compressor of air-breathing engines is significantly higher than in subsonic flight. As the present inventors observed, this limits the operational Mach range of an engine in two ways, whichever happens first.

First, the compressor rises the pressure of the flow. This implies an increase of its temperature too. This flow may be led to a combustion chamber, which will further increase its temperature before it expands through a turbine. The temperature increase in the combustion chamber (or, more precisely, between the compressor outlet and the turbine inlet) correlates with the useful outcome of that flow, i.e., how much thrust it can produce. The turbine entry temperature is typically fixed at the maximum allowable temperature for the turbine material. Thus, an increase of the compressor inlet temperature leads to an increase of the compressor outlet temperature and, in turn, a reduction of thrust. This loss of thrust defines the maximum operational flight Mach number of most conventional turbojet engines.

Second, the local speed of sound scales with the square root of the temperature. Therefore, the higher the temperature, the higher the local speed of sound. The compressor will be spinning at its design rotational speed, which is typically close to the maximum speed that can mechanically be supported by the compressor. Now, the Mach number related to this rotational speed (for example, the blade tip velocity divided by the local speed of sound) will decrease as the local speed of sound has increased. Moreover, the compressor performance scales with that rotation-related Mach number. Hence, the compressor performance will deteriorate.

To sum up, higher flight speed leads to higher inlet temperature, which leads to higher local speed of sound. This, in turn, leads to a lower Mach number, itself leading to a lower performance. A lower performance of the compressor means a lower mass flow, lower pressure ratio, and lower efficiency, which ultimately result in lower thermodynamic efficiency of the engine cycle and lower thrust. This ultimate loss of thrust defines the maximum operational flight Mach number of engines like air turborockets.

Based on these observations, the present inventors set themselves the challenge of designing a new concept of air turborocket having improved performance.

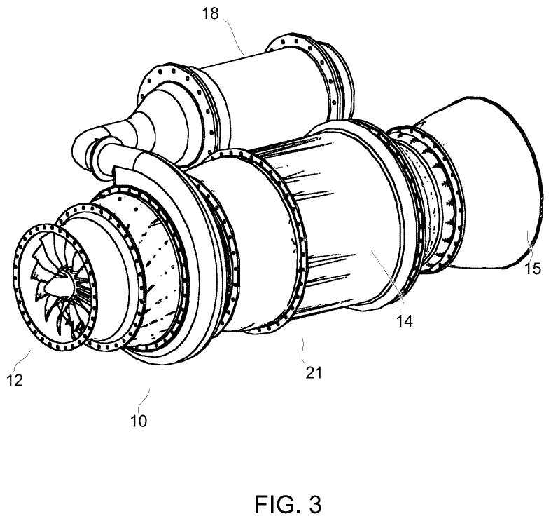

A first aspect of the invention is now described in reference to FIGS. 3-6 , which concerns an air turborocket apparatus 10. Note, this apparatus may consist of a sole air turborocket engine or include an air turborocket engine cooperating with additional aircraft components (such as a fuel tank, a pump, an external compressor, batteries, etc.), which together form an apparatus 10. The aircraft 1 itself concerns another aspect of the invention, which is described later.

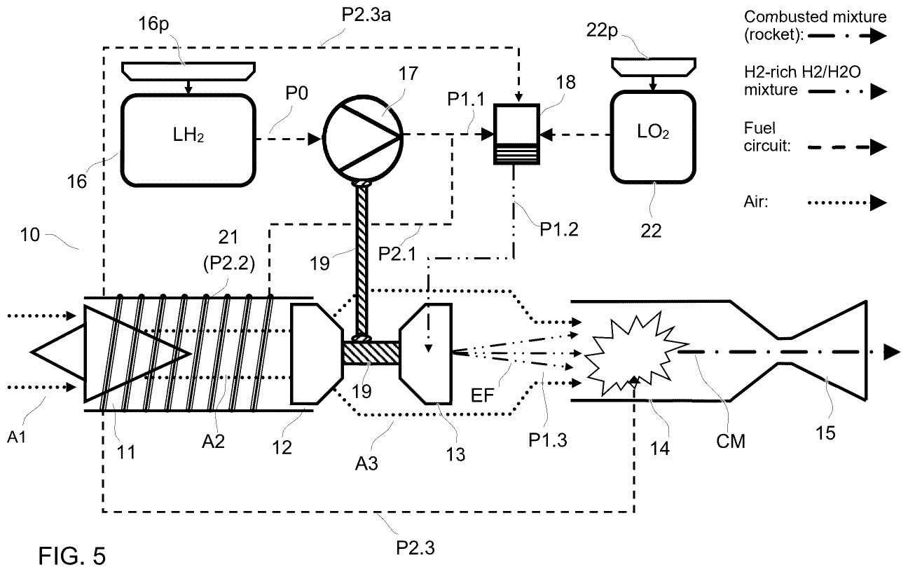

As seen in FIG. 5, the present air turborocket apparatus 10 comprises an air intake 11, a compressor 12, a turbine 13, a combustion chamber 14, and a gas generator system. The gas generator system itself includes a preburner 18 and a driving system 17, P1, P2. The apparatus 10 further includes a coupling system 19, which is configured to couple the turbine with the compressor and/or the driving system.

As further illustrated in FIG. 5, the driving system 17, P1, P2 is configured to drive fuel along two distinct flow paths P1, P2. The two flow paths P1, P2 include a first flow path P1 and a second flow path P2, which themselves decompose into sub-paths P1.1-P1.3 and P2.1-P2.3/P2.3a, respectively. The first flow path P1 extends to the combustion chamber 14, via the preburner 18 and the turbine 13, as usual. However, the second flow path P2 extends to the preburner 18 and/or the combustion chamber 14, via a heat exchanger 21 that is in thermal communication with the air intake 11. The second flow path P2 accordingly serves as an air precooler.

This has several advantages, which are discussed later in detail. Such advantages are better understood in light of the functions of the various components involved. To start with, the air intake 11 (also called air inlet) is designed to receive atmospheric air, the inlet flow of which is referred to as “A1” in FIG. 5. Various inlet designs are known (e.g., supersonic inlets, inlet cones, inlet ramps, etc.), which may be used in the present context. In general, the air intake is designed to ensure a smooth airflow into downstream components of the engine.

The compressor 12 is designed to compress a flow A2 of atmospheric air, as received from the air intake 11, in operation. In FIG. 5, the flow A3 denotes air compressed by the compressor 12. The flow A3 is directed to the combustion chamber 14. Various compressor designs may be contemplated, starting with usual multi-stage compressors.

The role of preburner 18 is to partly combust fuel; the resulting fluid is then expanded through the turbine 13. The preburner may possibly be arranged within the air turborocket engine, i.e., within a casing that encases the compressor 12, the turbine 13, and the combustion chamber 14, e.g., in close proximity with the compressor 12 and the turbine 13. This, however, may be challenging in terms of design, given the dimensions of the preburner relative to the main engine. Therefore, in preferred embodiments, however, the preburner 18 is arranged outside of the casing of the main engine, albeit in fluid communication with the turbine 13, as assumed in FIGS. 3 and 5.

The gas generator system is meant to generate a fluid flow to actuate the turbine 13 and feed the combustion chamber 14. The gas generator system includes a fluid circuit P0, P1, P2, which notably defines the above-mentioned flow paths P1, P2. The gas generator system further includes the driving system, which may notably include a pump system 17. The driving system is generally designed to drive a high-pressure fluid and convey the fluid along the fluid circuit P0, P1, P2.

In particular, the first flow path P1 has a section P1.2 extending from the preburner 18 to the turbine 13, to allow fuel partly combusted by the preburner 18 to expand through the turbine 13 and rotate the latter. In operation, the gas generator generates a flow of a fluid, which may be a liquid, a gas, or a supercritical fluid, notwithstanding the terminology “gas generator”. The state of matter may typically vary along the fluid circuit. For example, preferred embodiments rely on liquid hydrogen (LH₂), which is initially stored in a tank 16 (as a liquid), pumped, and conveyed along the fluid circuit, where it is subject to such pressures and temperatures that it changes to supercritical H₂ (above 13 bars and −240° C.). The supercritical phase of H₂ is typically achieved after the precooler 21, in operation. The role of the coupling system 19 is to couple the turbine 13 with one or each of the compressor 12 and one or more elements 17 of the driving system, with a view to transferring energy to the compressor 12 and/or the driving system. The coupling system 19 may for instance form a linkage between, on the one hand, the turbine 13 and, on the other hand, the compressor 12 and/or an element of the driving system such as a pump 17 or an external compressor (distinct from the compressor 12). This linkage may for example be a purely mechanical system, e.g., involving gearboxes. In that case, the turbine is rotatably coupled to the compressor 12 and/or elements of the driving system 17.

In more sophisticated variants, the turbine 13 is indirectly coupled to the compressor and/or driving system, via an electromechanical system. For example, the apparatus 10 may include a battery (not shown). In that case, power required by the compressor 12 and/or the driving system 17 is provided both by the turbine 13 and the battery, rather than the sole turbine 13. In all cases, however, the energy produced by rotating the turbine 13 causes (or, at least, contributes to cause) to rotate the compressor 12 and/or actuate the driving system 17, whether by directly transferring mechanical energy or by first converting this energy to electrical power. In preferred embodiments, the coupling system is designed so that the turbine 13 drives (or contributes to drive) both the compressor 12 and a pump 17 of the driving system.

The combustion chamber 14 (also referred to as afterburner) is designed to receive and combust a mixture of fuel, compressed atmospheric air, and potentially other species e.g., water, should the fuel initially consist of liquid hydrogen, as in preferred embodiments. In operation, the chamber 14 continuously burns the expanded fluid EF after initial ignition during the engine start.

A nozzle 15 (or any exhaust system, e.g., designed as a thrust chamber) is typically arranged downstream of the combustion chamber 14, so as to expel the combusted mixture CM and thereby create thrust, in operation of the apparatus 10. That is, the combusted mixture (exhaust gas) passes through the propelling nozzle 15 to produce a high velocity jet. Various nozzle configurations may be involved. The nozzle may notably be configured as a supersonic nozzle.

The preburner 18 and the combustion chamber 14 are preferably made of a high-performance material that can withhold high temperatures. Examples of such materials include aerospace standard stainless steel, titanium alloys, and nickel alloys. The ratio of a characteristic diameter of the preburner 18 to the engine diameter will typically be between ⅙ and 1 (see FIG. 3), although the preburner may possibly be scaled down, depending on the preburner type and performance sought.

The first flow path P1 is designed so that fuel driven along the first flow path is first injected into the preburner 18 (see the sub-path P1.1, FIG. 5), for it to partly combust the injected fuel. The resulting fluid is then conveyed along the sub-path P1.2 and expanded through the turbine 13. This causes to rotate the turbine 13 and accordingly transfer energy to one or each of the compressor 12 and the driving system 17, via the coupling system 19. The expanded fluid EF is finally guided to the combustion chamber 14.

The second flow path P2 is designed to convey fuel to one or each of the preburner 18 and the combustion chamber 14, albeit through the heat exchanger 21 that is in thermal communication with the air intake 11. So, the combustion chamber receives and combusts a mixture of atmospheric air A3 (as compressed by the compressor 12 and guided to the combustion chamber 14), the expanded fluid EF and, if necessary, additional fuel conveyed via the heat exchanger 21. Conversely, the preburner receives and combusts a mixture of an oxidizer (e.g., oxygen coming from a liquid oxygen tank 22), fuel conveyed along the first flow path P1, and, if necessary, additional fuel conveyed via the heat exchanger 21. The second flow path P2 amounts to inserting a new heat source (the breathed air as guided A2 by the air intake 11) in the fluid circuit and providing a heat exchange surface to maximize the heat transfer rate. This way, part of the fuel is used to cool down air received via the air intake 11, prior to being combusted either in the preburner 18 or the combustion chamber 14. The efficiency of the precooler determines the extent to which air cools down and fuel heats up. The precooling will be more significant if the precooler has higher efficiency. In all cases, however, the precooling is beneficial, inasmuch as it allows a fraction of fuel to be preheated, readying it for subsequent combustion. Eventually, this preheating makes it possible to save the energy that would have been necessary to bring this fraction of fuel to the same temperature.

That being said, there are operational limits to the extent to which air A1 breathed by the air intake 11 can be cooled down. I.e., every flight condition will come with an optimal precooler control set, and a trade-off will have to be made between heating up the fuel as much as possible and cooling down the air to an optimal temperature.

Preferred embodiments rely on Liquid hydrogen (LH₂), which is routed through an annular heat exchanger 21 around the air intake 11, upstream of the compressor 12 of the air-breathing engine. As the liquid hydrogen conveyed through the second flow path P2 is at very low temperatures, it cools down the air coming into the compressor. This effectively extends the flight Mach number operational range of the engine. The hydrogen further heats up as it runs through the precooler. It may then be favourably injected in the preburner 18 or a combustion chamber 14 (i.e., the afterburner).

The proposed solution helps counteract the speed-induced heating of the air flow. This makes it possible to extend the flight Mach number operational range of the engine. Another consequence is that preheating a fraction of the liquid hydrogen saves energy. It may notably reduce the consumption of oxygen injected in the preburner or oxygen present in the compressed air arriving in the combustion chamber.

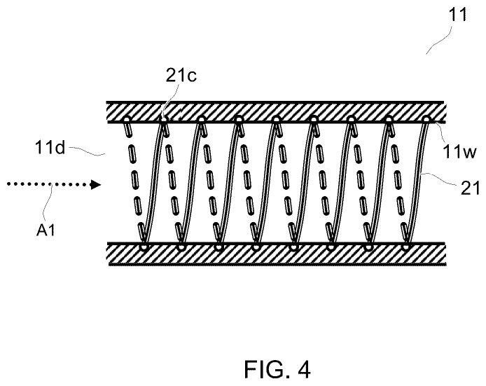

All this is now described in detail, in reference to particular embodiments of the invention. To start with, as illustrated in FIG. 4, the internal conduit of the air intake 11 is defined by an inner wall 11w. I.e., this wall 11w defines a duct 11d forming a passageway for atmospheric air A1. Now, the heat exchanger 21 is preferably forming part of the second flow path P2. In particular, the heat exchanger 21 may include a conduit (e.g., having a tubular cross-section 21c), which forms a portion P2.2 of the second flow path P2 (see also FIG. 5), whereby the conduit 21 is in thermal contact (i.e., in thermal communication) with atmospheric air drawn through the air intake 11, in operation.

The conduit 21 preferably extends along a winding path along at least a portion of the inner wall 11w, whereby successive portions of the conduit 21 are typically parallel to each other, which increases the density of fluid in thermal contact with the air flow A2. The conduit 21 may form a variety of pattern. For example, the conduit 21 may be coiled and/or meandering around at least a portion of the duct 11d. This results in a dense arrangement of the conduit portions, which makes it possible to more efficiently transfer heat generated by the received air to the fuel conveyed along the coiled conduit 21. I.e., the fuel acts as a more efficient precooler. In the example of FIGS. 4 and 5, the conduit 21 is assumed to be coiled around a portion of the inner wall 11w. However, other patterns are possible (e.g., meanders), which may result in a dense arrangement too.

In variants to conduit sections, the heat exchanger 21 is configured as a cooling jacket or includes microchannels. A characteristic dimension of the heat exchanger (e.g., the cooling jacket thickness, the cross-sectional diameter of the microchannels or the conduit 21) will typically be on the order of 1/200 of the engine diameter. This dimension may possibly be scaled down, the manufacturing process permitting.

In “thermal contact with” means that a substantial heat exchange can effectively be measured, which improves the performance of the downstream combustion. For example, the conduit 21 can be in direct mechanical contact with the inner wall 11w, assuming that the conduit is made of a material that sufficiently conducts heat. This ensures a satisfactory thermal contact and, in turn, improves the heat exchange with air A2 breathed by the air intake 11. More generally, the conduit 21 is preferably arranged so as to come as close as possible to the duct 11d and, in fact, the air A2. The conduit may for instance be made integral with the inner wall 11w, or somehow be level with it, as assumed in FIG. 4. This conduit may for instance be a metal tube, e.g., a tube having diameter between 0.5 mm and 5.0 mm. Similar metal tubes may be used in other portions of the fluid circuit. The latter may possibly include additional heat exchangers (not shown), to leverage heat transfers.

Preferably, the precooler 21 is designed so as to reach a heat transfer rate between 0.5 and 2 MW/(kg/s), e.g., 1 MW/(kg/s), assuming the fuel used is hydrogen. The mass flow units refer to the fuel flow conveyed through the conduit 21. That is, if 1 kg/s of fuel are to be run through the conduit 21, the goal is to transfer heat at a rate of 1 MW. Achieving this value will depend on other design parameters and desired trade-offs, in particular the heat exchanger configuration, the expected flows (air and hydrogen), and the hydrogen pressure. A significant thermal contact area is preferably relied on, e.g., up to 1000 m². Fins can optionally be used to increase the transfer efficiency and lower the area requirement, if necessary.

In embodiments, the driving system 17, P1, P2 includes a pump system 17, which is designed to pump fuel. The driving system may possibly include several pumps, forming a pump system. Alternatively, the driving system includes a single pump, e.g., a centrifugal pump 17. Such a solution result in a fairly simple engineering, while allowing a high flow rate. As seen in FIG. 5, the flow paths P1, P2 form part of a fluid circuit arranged downstream of the pump system 17. The driving system is meant to drive the pumped fuel along each of the first flow path P1 and the second flow path P2, in operation.

As said, the second flow path P2 extends to the combustion chamber 14 and/or the preburner 18, see the sub-paths P2.3 and P2.3a. In each case, pre-heating the fuel conveyed along the respective sub-paths P2.3 and P2.3a benefits to the subsequent combustion. In embodiments, the second flow path P2 extends to the combustion chamber 14 only, via the sub-path P2.3 (there is no sub-path P2.3a). I.e., in that case, the combustion chamber 14 receives and combusts a mixture of compressed atmospheric air A3, the expanded fluid EF, and additional fuel conveyed along the second flow path P2, via the last sub-path P2.3.

In variants, the second flow path P2 extends to the preburner 18 only, via the sub-path P2.3a (there is no sub-path P2.3 in that case). So, in operation, fuel injected into the preburner 18 contains fuel driven along each of the sub-paths P1.1 and P2.3a. In other variants, the second flow path P2 has a bifurcation, leading to each of the preburner 18 (via the sub-path P2.3a) and the combustion chamber 14 (via the sub-path P2.3).

As further seen in FIG. 5, the second flow path P2 preferably branches from the first flow path P1 (downstream of the pump 17, at the level of the sub-path P1.1). Where the second flow path P2 includes a sub-path P2.3a leading to the preburner 18, the sub-path P2.3a may branch back into the first flow path P1, e.g., upstream of the preburner 18. In variants, the sub-path P2.3a may independently inject pre-heated fuel in the preburner 18, as assumed in FIG. 5.

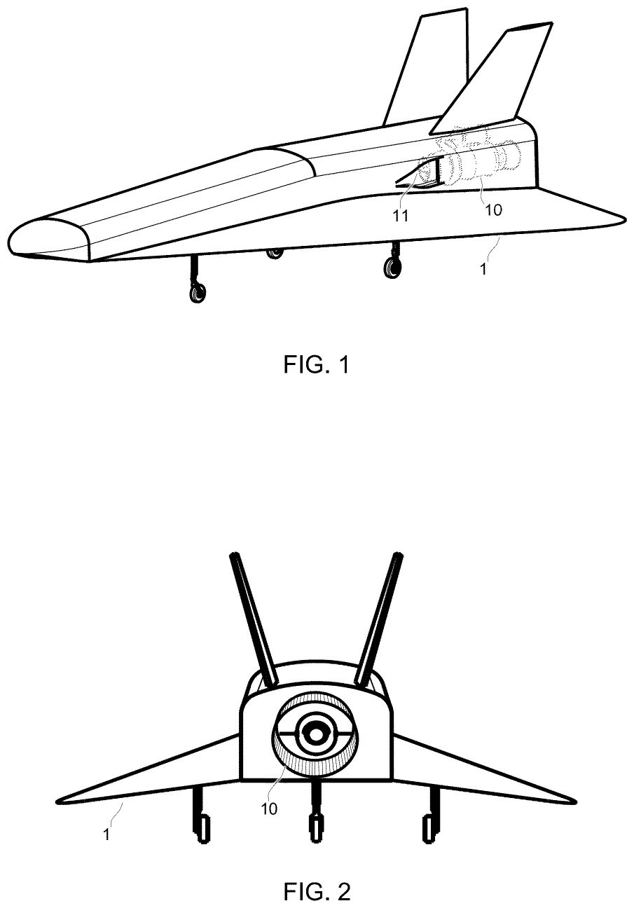

Referring to FIGS. 1 and 2, another aspect of the invention concerns an aircraft 1, which is equipped with one or more air turborocket apparatuses 10 as described above in reference to FIGS. 3-6. The aircraft 1 may notably be a drone or a high-speed plane, such as a supersonic or hypersonic plane. As usual, the aircraft 1 includes an aircraft structure (or airframe). The internal load bearing structure is a structural assembly typically made from frames, stringers, spars, ribs, and panels, which are usually machined or formed from sheet metal. The airframe houses a number of components, starting with the air turborocket(s) engine 10.

As illustrated in FIG. 5, the aircraft further includes one or more fuel tanks 16, to which the driving system 17, P1, P2 is connected. Each fuel tank 16 is preferably meant to contain liquid hydrogen. The aircraft may further include a pressurization system 16p, designed to pressurize liquid fuel contained in the fuel tank 16. The aircraft may additionally include one or more oxidizer tanks 22, to which the preburner 18 is connected. Each oxidizer tank 22 is preferably meant to contain liquid oxygen, in operation. The aircraft may further include a pressurization system 22p designed to pressurize liquid oxidizer contained in the oxidizer tanks 22. A single fuel tank 16 and a single oxidizer tank 22 are assumed in FIG. 5, for simplicity. Each pressurization system 16p, 22p typically relies on gaseous Helium to apply pressure to the tanks 16, 22.

A preferred arrangement of the fluid circuit is shown in FIG. 5. The fluid circuit includes an upstream flow path P0 between the fuel tank 16 and the pump 17 for the latter to pump fuel from the fuel tank 16, in operation. The fuel tank 16 is pressurized by the pressurization system 16p. The first flow path P1 extends from the pump system 17 to the preburner 18 to the turbine 13 to the combustion chamber 14. The first flow path P1 decomposes into sub-paths P1.1, P1.2, and P1.3. The first sub-path P1.1 extends from the pump 17 to the preburner 18, for the latter to partly combust fuel conveyed along this sub-path P1.1. The second sub-path P1.2 extends from the preburner 18 to the turbine 13, for a fluid containing the fuel partly combusted by the preburner 18 to reach the turbine 13, expand through the turbine 13, and rotate it, in order to energize the pump 17 and/or the compressor 12. The sub-path P1.3 guides the expanded fluid EF to the combustion chamber 14, where it is combusted, together with compressed air A3.

The second flow path P2 decomposes into sub-paths P2.1, P2.2, and P2.3 and/or P2.3a. The first portion P2.1 of the second flow path branches from the portion P1.1 (downstream of the pump 17) and goes to the heat exchanger 21. The latter is realized as a conduit having a tubular cross-section 21c. The conduit forms a further sub-path P2.2, which is coiled around the duct 11d formed by the air intake, as described earlier in reference to FIG. 4. The output of the conduit 21 leads to the sub-paths P2.3 and/or P2.3a, respectively leading to the combustion chamber 14 and/or the preburner 18.

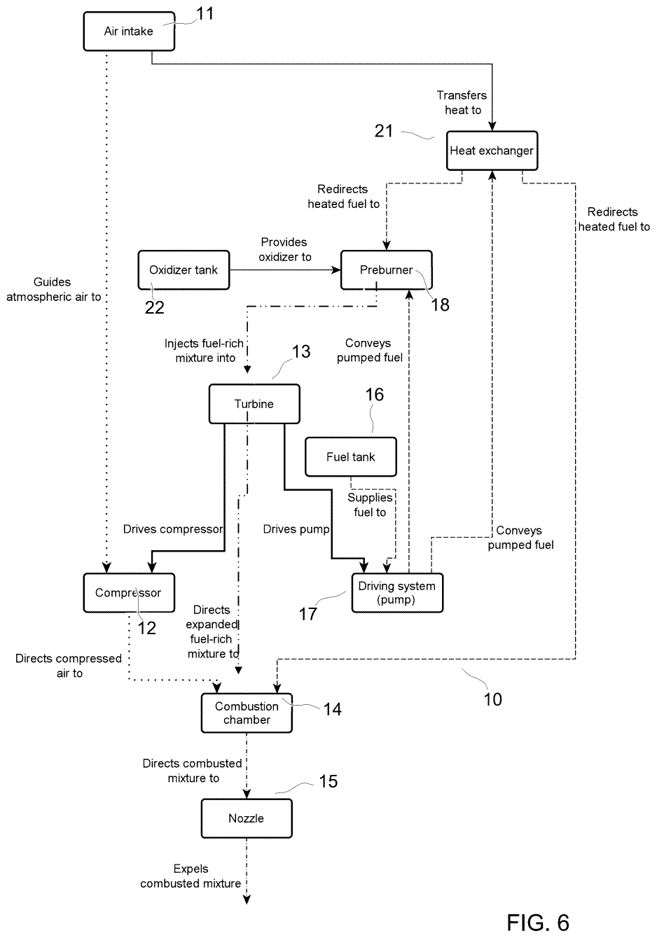

As illustrated in FIGS. 5 and 6, the coupling system 19 is generally configured to couple the turbine 13 with the compressor 12 and/or the driving system 17, to (at least) contribute to drive the compressor 12 and/or the driving system 17. In embodiments, the turbine is coupled to the sole compressor 12. I.e., the turbine 13 and the compressor 12 form a turbine-compressor assembly in that case. As said, the rotation of the compressor may be entirely driven by the rotating turbine, via gearboxes. The mechanical energy of the rotated turbine 13 is transferred to rotate the compressor 12. In variants, the rotated turbine may only be indirectly coupled to the compressor. For example, the rotation of the turbine may first be converted into electrical power, which is then used to rotate the compressor 12. Part of the electrical power generated by the turbine 13 may be used to power other components of the apparatus 10, if needed. Additional electric power (e.g., from an external battery) may also be applied to actuate the compressor 12, if necessary. In that case, the turbine rotation only contributes to rotate the compressor 12, which is secondarily powered by another source.

The pump system 17 requires power too, hence the benefit of harnessing power generated from the turbine 13. Thus, in embodiments, the coupling system 19 couples the turbine 13 with the pump 17, whereby the rotated turbine 13 actuates (or contributes to actuate) the pump 17. In preferred embodiments, the turbine rotation is exploited to actuate both the compressor 12 and the pump 17. Again, the turbine may only be indirectly coupled to such elements, which may further be secondarily powered by another source (e.g., a battery), if necessary.

FIG. 6 describes the functions of the components shown in FIG. 6. The air intake 11 breathes atmospheric air A1 and guides air A2 to the compressor 12, which compresses air A2 and directs the compressed air A3 to the combustion chamber 14. The arrangement of the heat exchanger 21 (as a coiled conduit 21) results in that the air intake 11 transfers heat from the guided air A2 to fuel conveyed through the sub-path P2.2. This fuel is redirected to the combustion chamber 14 and/or the preburner 18. The fuel-rich mixture resulting from the partial combustion at the preburner 18 is injected in and expanded by the turbine 13. This causes to rotate the turbine 13, which produces energy that is leveraged to drive the compressor 12 and/or the pump 17. The latter pumps fuel from the tank 16 (itself pressurized by the pressurization means 16p, not shown in FIG. 6) and the pumped fuel is injected in the fluid circuit, which notably results in conveying fluid along each flow path P1 and P2, whereby fuel is driven to, on the one hand, the preburner 18 (via the first flow path P1) and, on the other hand, indirectly to the combustion chamber 14 and/or the preburner 18 (via the second flow path P2). The oxidizer tank 22 (pressurized by pressurization means 22p, not shown in FIG. 6) is in fluid communication with the preburner 18, to inject oxidizer into the preburner. The combustion chamber 14 combusts the fuel-rich mixture expanded by the turbine 13 with compressed air A3, as well as fuel redirected via the sub-path P2.3, if any. The combusted mixture CM is then directed to the nozzle 15, which expels the combusted mixture to create thrust.

A final aspect of the invention concerns a method of operating an air turborocket apparatus 10 as described above. Essential features of the method have already been described earlier, be it implicitly, in reference to FIGS. 3-6. The method essentially revolves around operating the air turborocket apparatus 10 for the air intake 11 to receive atmospheric air A1, the compressor 12 to compress atmospheric air A2 drawn through the air intake (i.e., air received from the air intake 11), and the driving system 17, P1, P2 to drive fuel along a first flow path P1 and a second flow path P2. As explained above, fuel driven along the first flow path P1 is injected into the preburner 18 and partly combusted therein. A fluid EF containing the partly combusted fuel is then expanded through the turbine 13 to rotate it and transfer energy to one or each of the compressor 12 and the driving system 17, P1, P2. The expanded fluid is guided to the combustion chamber 14, for it to combust a mixture of the compressed atmospheric air A3 and a fluid including the expanded fluid EF. Meanwhile, fuel is driven along the second flow path P2. This fuel is heated up via the heat exchanger 21 and then injected into the preburner 18 and/or the combustion chamber 14, with benefits as described earlier.

While the present invention has been described with reference to a limited number of embodiments, variants, and the accompanying drawings, it will be understood by those skilled in the art that various changes may be made, and equivalents may be substituted without departing from the scope of the present invention. In particular, a feature (device-like or method-like) recited in a given embodiment, variant or shown in a drawing may be combined with or replace another feature in another embodiment, variant or drawing, without departing from the scope of the present invention. Various combinations of the features described in respect of any of the above embodiments or variants may accordingly be contemplated, that remain within the scope of the appended claims. In addition, many minor modifications may be made to adapt a particular situation or material to the teachings of the present invention without departing from its scope. Therefore, it is intended that the present invention is not limited to the particular embodiments disclosed, but that the present invention will include all embodiments falling within the scope of the appended claims. In addition, many other variants than explicitly touched above can be contemplated. For example, the apparatus 10 may involve other materials and other components than those explicitly mentioned above. In addition, other air turborocket designs may be contemplated, which may depart from the design shown in FIGS. 3 and 5.

### REFERENCE LIST

1 Aircraft
10 Air turborocket apparatus
11 Air intake
11d Duct
11w Inner wall of air intake (duct)
12 Compressor
13 Turbine
14 Combustion chamber
15 Nozzle
16 Fuel tank
16p Fuel tank pressurization means
17 Pump system (e.g., centrifugal pump)
17, P1, P2 Driving system (including pump system)
18 Preburner
19 Coupling system
21 Heat exchanger (conduit)
21c Conduit cross-section
22 Oxidizer tank
22p Oxidizer tank pressurization means
P0, P1, P2 Fluid circuit
P0 Upstream path
P1 (P1.1, P1.2, P1.3) First flow path
P2 (P2.1, P2.2, P2.3, P2.3a) Second flow path
A1 Atmospheric air received by the air intake
A2 Atmospheric air led to the compressor
A3 Compressed atmospheric air
CM Combusted mixture
EF Expanded fluid

1. An air turborocket apparatus comprising:
an air intake;
a compressor;
a turbine;
a combustion chamber;
a gas generator system including a preburner and a driving system; and
a coupling system configured to couple the turbine with one or each of the compressor and the driving system, wherein
the driving system is configured to drive fuel along two flow paths the two flow paths including
a first flow path extending to the combustion chamber via the preburner and the turbine and
a second flow path extending to one or each of the preburner and the combustion chamber, via a heat exchanger in thermal communication with the air intake.

2. The air turborocket apparatus according to claim 1, wherein
the air intake has an inner wall that defines a duct forming a passageway for atmospheric air, and
the heat exchanger includes a conduit forming a portion of the second flow path, whereby the conduit is in thermal contact with atmospheric air drawn through the air intake, in operation.

3. The air turborocket apparatus according to claim 2, wherein
the conduit extends along a winding path along at least a portion of the inner wall.

4. The air turborocket apparatus according to claim 3, wherein
the conduit is coiled around and/or meandering along said at least a portion of the inner wall.

5. The air turborocket apparatus according to claim 2, wherein
the conduit is in direct contact with said inner wall.

6. The air turborocket apparatus according to claim 1, wherein
the driving system includes a pump system, which is designed to pump fuel, and
the first flow path and the second flow path form part of a fluid circuit arranged downstream of the pump system, the fluid circuit defining the two flow paths, for the driving system to drive pumped fuel along each of the first flow path and the second flow path, in operation.

7. The air turborocket apparatus according to claim 6, wherein
the pump system includes a centrifugal pump.

8. The air turborocket apparatus according to claim 1, wherein
the second flow path extends to the combustion chamber.

9. The air turborocket apparatus according to claim 1, wherein the second flow path extends to the preburner.

10. The air turborocket apparatus according to claim 9, wherein
the second flow path branches from the first flow path and branches back into the first flow path.

11. The air turborocket apparatus according to claim 1, wherein
the coupling system couples the turbine to each of the compressor and the driving system, so as to transfer energy to each of the compressor and the driving system upon rotating the turbine.

12. The air turborocket apparatus according to claim 1, wherein
the coupling system couples the turbine to the driving system, so as to transfer energy only to the driving system upon rotating the turbine.

13. The air turborocket apparatus according to claim 11, wherein
the coupling system couples the turbine to the compressor, so as to transfer energy only to the compressor upon rotating the turbine.

14. The air turborocket apparatus according to claim 1, wherein
the apparatus includes a casing, which encases the compressor, the turbine, and the combustion chamber, and the preburner is arranged outside of the casing, albeit in fluid communication with the turbine.

15. An aircraft
comprising one or more air turborocket apparatuses, each comprising:
an air intake:
a compressor;
a turbine;
a combustion chamber;
a gas generator system including a preburner and a driving system; and
a coupling system configured to couple the turbine with one or each of the compressor and the driving system. wherein
the driving system is configured to drive fuel along two flow paths, the two flow paths including
a first flow path extending to the combustion chamber via the preburner and the turbine, and
a second flow path extending to one or each of the preburner and the combustion chamber, via a heat exchanger in thermal communication with the air intake.

16. The aircraft according to claim 0, wherein
the aircraft further includes one or more fuel tanks to which the driving system is connected.

17. The aircraft according to claim 16, wherein
the aircraft further includes a pressurization system designed to pressurize liquid fuel contained in the one or more fuel tanks.

18. The aircraft according to claim 0, wherein
the aircraft further includes one or more oxidizer tanks, to which the preburner is connected.

19. The aircraft according to claim 0, wherein
the aircraft further includes a pressurization system designed to pressurize a liquid oxidizer contained in the one or more oxidizer tanks.

20. A method of operating an air turborocket apparatus, the method comprising:
providing an air turborocket apparatus comprising an air intake, a compressor, a turbine, a combustion chamber, a gas generator system including a preburner and a driving system, and a coupling system configured to couple the turbine with one or each of the compressor and the driving system, wherein the driving system is configured to drive fuel along two flow paths, the two flow paths including
a first flow path extending to the combustion chamber via the preburner and the turbine, and
a second flow path extending to one or each of the preburner and the combustion chamber, via a heat exchanger in thermal communication with the air intake;
operating the air turborocket apparatus for
the air intake to receive atmospheric air,
the compressor to compress atmospheric air received by the air intake, and
the driving system to drive fuel
along the first flow path to inject fuel into the preburner and partly combust the injected fuel, expand a fluid containing the partly combusted fuel through the turbine and rotate it, to transfer energy to one or each of the compressor and the driving system, and guide the expanded fluid to the combustion chamber, for it to combust a mixture of the compressed atmospheric air and a fluid including the expanded fluid, and
along the second flow path to heat up fuel via the heat exchanger and inject the heated fuel into the preburner and/or the combustion chamber.
